(19) United States
(12) Patent Application Publication
(10) Pub. No.: US 2010/0299422 A1
(43) Pub. Date: Nov. 25, 2010

(54) CLIENT MANAGEMENT SYSTEM

(75) Inventor: TOMONORI HIRAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/546,327

(22) Filed: Aug. 24, 2009

(30) Foreign Application Priority Data
May 21, 2009 (CN) 200910302506.7

(51) Int. Cl. G06F 15/173

(52) U.S. Cl. 709/223

(57) ABSTRACT

A client management system includes a client terminal capable of communicating with a server terminal. The client terminal includes a storage device and a security managing module. The storage device is capable of storing data checked out data from the server terminal. The security managing module is capable of deleting the checked-out data in the storage device when a checked-out period determined by the server terminal has expired.

### BACKGROUND

1. Technical Field

The present disclosure relates to client management systems, and particularly to a client management system with a client terminal which has a storage device.

2. Description of Related Art

Thin client terminals are widely used in LANs because of their low cost. However, thin client terminals usually do not have a hard disk drive and so cannot store files, and must access files in a server terminal via a network. So, if the network is offline, the thin client terminal cannot do any work.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a client management system.

FIG. 2 is a flow chart illustrating a using process of the client management system of FIG. 1.

### DETAILED DESCRIPTION

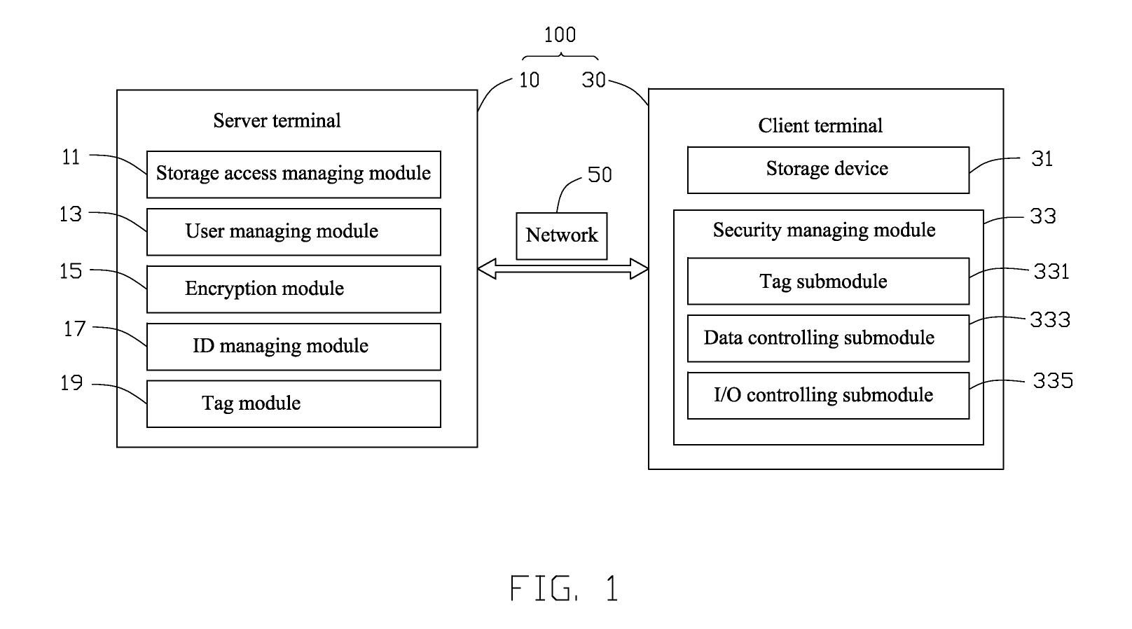

Referring to FIG. 1, an embodiment of a client management system 100 includes a server terminal 10, and a client terminal 30 in communication with the server terminal 10 via a network 50.

The server terminal 10 includes a storage access managing module 11, a user managing module 13, an encryption module 15, an identification (ID) managing module 17, and a tag module 19.

The storage access managing module 11 is capable of determining authorization for accessing data of the server terminal 10 by the client terminal 30 (e.g., the client terminal 30 is allowed by the storage access managing module 11 to access files in a folder stored in the server terminal 10). The user managing module 13 is capable of defining status in which the user can access the data of the server terminal 10. The status includes a check out status and a check in status. In the check out status, the user can check out the authorized data from the server terminal 10 to the client terminal and perform operations on the data such as deleting, editing, or adding, and can check in the data from the client terminal 30 to the server terminal 10. In the check in status, the user can check in the data from the client terminal to the server terminal 10, but cannot check out the data from the server terminal 10 to the client terminal 30. The user managing module 13 is further capable of determining a checked-out period, during which the user can check out the data from the server terminal 10 to the client terminal 30 and manipulate the data in the client terminal 30. However, after the determined checked-out period, the user cannot check in the checked-out data from the client terminal 30 to the server terminal 10, and the checked-out data in the client terminal 30 will be cleared by the client terminal 30. The encryption module 15 is capable of having user to configure password and user name which would be allowed to access the server terminal 10, and capable of verifying password and name inputted by a user who wants to access the server terminal 10. The ID managing module 17 is capable of assigning an ID, such as internet protocol (IP) address, to the client terminal 30. The tag module 19 is capable of marking the checked-out data and keeping a history of the data checked-out by the user, including tracking the checked-out and checked-in data, recording a history of changes to the data, recording information of the user who checked out or checked in the data.

The client terminal 30 includes a storage device 31, and a security managing module 33. The storage device 31 is capable of storing data, which includes the data checked out from the server terminal 10 to the client terminal 30. The security managing module 33 includes a tag submodule 331, a data controlling submodule 222, and an I/O controlling submodule 335. The tag submodule 331 is capable of marking the checked-out data in the client terminal 30, and keeping all history of the data accessed by the user, such as including tracking the checked-out and checked-in data, recording a history of changes to the data. The data controlling submodule 333 is capable of defining a checked-out time from when the data of the server terminal 10 is checked-out to the storage device 31, judging whether the checked-out time is beyond the determined checked-out time, and deleting the data tracked by the tag submodule 331 when the checked-out time is beyond the determined checked-out period. The I/O controlling submodule 335 is capable of preventing the data tracked by the tag submodule 331 being copied to other storage devices through I/O ports of the client terminal 30.

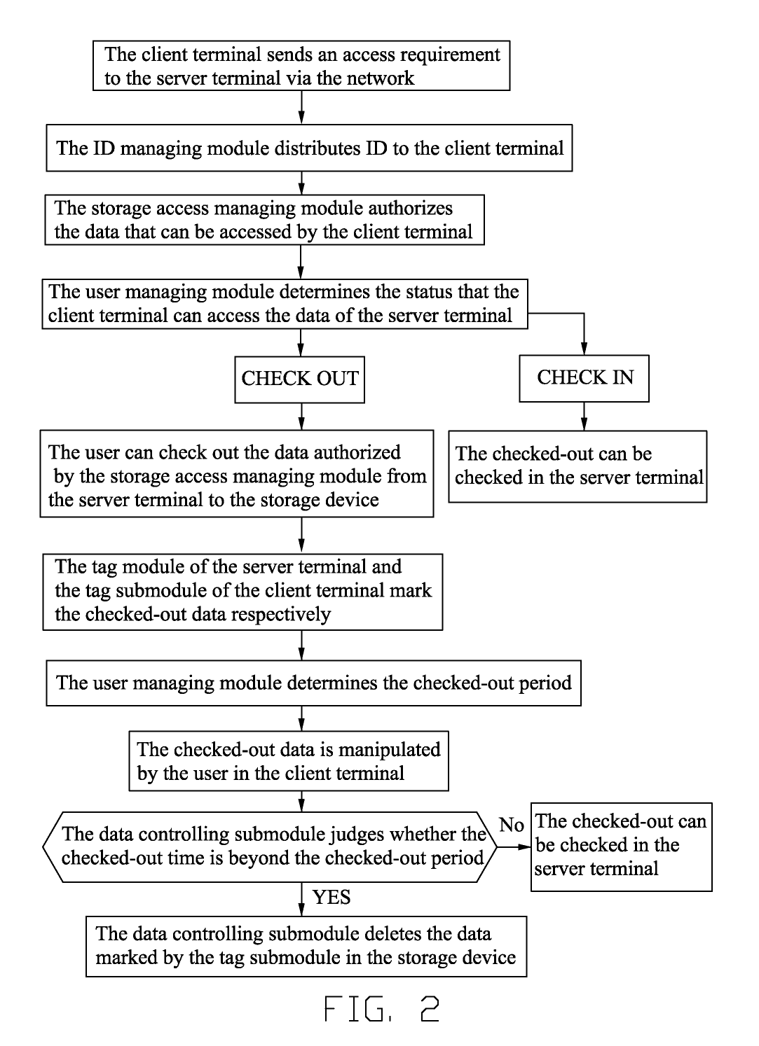

Referring also to FIG. 2, in use, the client terminal 30 sends an access requirement to the server terminal 10 via the network 50. The server terminal 10 receives the access requirement, and the ID managing module 17 assigns an ID to the client terminal 30. The storage access managing module 11 authorizes the data that can be accessed by the client terminal 30. The encryption module 15 verifies the user password and user name for accessing the server terminal 10. The user managing module 13 defines under what status the client terminal 30 can access the data of the server terminal 10. The client terminal 30 then accesses the server terminal 10 by using the ID assigned by the server terminal 10. The user can log into the server terminal 10 by entering the correct user name and password, and access the data of the server terminal 10 according to the defined status.

If the user accesses the data of the server terminal 10 under the check out status defined by the user managing module 13, the user can check out the data authorized by the storage access managing module 11 from the server terminal 10 to the storage device 31 of the client terminal 30, and manipulates the checked-out data. The tag module 19 of the server terminal 10 and the tag submodule 331 of the client terminal 30 each marks the checked-out data and keeps all history of the checked-out data. The user managing module 13 determines the checked-out period, and the data controlling submodule 333 starts to calculate the checked-out time. The data controlling submodule 333 judges whether the checked-out time is beyond the checked-out period. If the checked-out time is not beyond the checked-out period, the checked-out data can be manipulated by the user on the client terminal 30, and can be checked back into the server terminal 10 from the client terminal 30 after manipulated. If the checked-out time is beyond the checked-out period, the checked-out data cannot be checked back into the server terminal 10 and any data cannot be checked out from the server terminal 10 to the client terminal 30 again. At the same time, the data controlling submodule 333 deletes the data marked by the tag submodule 331 in the storage device 31 when the checked-out time is beyond the checked-out period.

In the procedure described above, the I/O controlling submodule 335 can prevent unauthorized copying of the data marked by the tag submodule 331 to other storage devices through I/O ports of the client terminal 30. In addition, after the data is checked out to the storage device 31, the checked-out data can be manipulated by the user on the client terminal 30, even if the client terminal 30 is offline from the network 50.

If the user accesses the data of the server terminal 10 under the check in status defined by the user managing module 13, the data of the server terminal 10 cannot be checked out to the storage device 31 of the client terminal 30, but the data stored in the storage device 31 can be checked into the server terminal 10.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A client management system, comprising:
a client terminal capable of communicating with a server terminal, the client terminal comprising a storage device and a security managing module, wherein the storage device is capable of storing data checked out data from the server terminal; the security managing module is capable of deleting the checked-out data in the storage device when a checked-out period determined by the server terminal has expired.

2. The client management system of claim 1, wherein the server terminal comprises a tag module capable of marking the data which is checked out from the server terminal.

3. The client management system of claim 1, wherein the security managing module comprises a tag submodule capable of marking and tracking history of the checked-out data.

4. The client management system of claim 3, wherein the security managing module further comprises a data controlling submodule capable of judging whether the checked-out period has expired.

5. The client management system of claim 4, wherein when the checked-out period has expired, the security managing module is capable of deleting the checked-out data on the storage device is by the data controlling submodule.

6. The client management system of claim 1, wherein the security managing module comprises an I/O controlling submodule capable of preventing the checked-out data from copying to other storage device by I/O ports of the client terminal.

7. The client management system of claim 1, wherein the server terminal comprises a encryption module capable of configuring and verifying a user password and user name for accessing the server terminal.

8. A client management system, comprising:
a client terminal capable of communicating with a server terminal via a network and checking out data from the server terminal, the client terminal comprising a storage device and a security managing module, wherein the storage device is capable of storing and manipulating the checked out data, the security managing module is capable of defining a checked-out time from when the data is checked out to the storage device, and capable of deleting the checked-out data in the storage device when the checked-out time is beyond a predetermined checked-out period.

9. The client management system of claim 8, wherein the predetermined checked-out period is defined by the server terminal.

10. The client management system of claim 8, wherein the security managing module comprises a tag submodule capable of marking and tracking history of the checked-out data.

11. The client management system of claim 10, wherein the security managing module further comprises a data controlling submodule capable of counting the checked-out time, and judging whether the checked-out time is beyond the checked-out period.

12. The client management system of claim 11, wherein when the checked-out time is beyond the checked-out period, the security managing module is capable of deleting the checked-out data from the storage device is by the data controlling submodule.

13. The client management system of claim 8, wherein the security managing module comprises an I/O controlling submodule capable of preventing the check-out data from being copied to other storage device by I/O ports of the client terminal.
